(19) United States
(12) Patent Application Publication
(10) Pub. No.: US 2026/0044932 A1
(43) Pub. Date: Feb. 12, 2026

(54) DEEP LEARNING-BASED SUPER-RESOLUTION FLUORESCENCE LIFETIME IMAGING MICROSCOPY METHOD

(71) Applicant: SHENZHEN UNIVERSITY, Shenzhen (CN)

(72) Inventors: Junle QU, Shenzhen (CN); Qinglin CHEN, Shenzhen (CN); Luwei WANG, Shenzhen (CN); Xuegang ZHU, Shenzhen (CN); Liwei LIU, Shenzhen (CN); Xiaoyu WENG, Shenzhen (CN)

(21) Appl. No.: 19/315,421

(22) Filed: Aug. 29, 2025

Related U.S. Application Data
(63) Continuation of application No. PCT/CN2025/086786, filed on Apr. 2, 2025.

(30) Foreign Application Priority Data
Aug. 9, 2024 (CN) 202411089304.X

(51) Int. Cl. G06T 3/4053; G01N 21/64; G06T 3/4046

(52) U.S. Cl. CPC G06T 3/4053; G01N 21/6458; G06T 3/4046

(57) ABSTRACT

A deep learning-based super-resolution fluorescence lifetime imaging microscopy (SR-FLIM) method includes the steps of: S1, performing fluorescence microscopic imaging on a sample to obtain confocal intensity images and stimulated emission depletion (STED) intensity images at a same location; S2, co-registering the acquired confocal and STED intensity images; S3, pairing the co-registered confocal and STED intensity images as input (Input) and ground truth (GT) to assemble a dataset; S4, partitioning the dataset into training and validation sets following a predefined ratio; and S5, constructing a network, and selecting hyperparameters and an optimizer. This method may achieve SR-FLIM within a conventional confocal FLIM system, surpassing spatial resolution limitations of FLIM, breaking through resolution barriers of conventional optical microscopy, while preserving normal fluorescence lifetime characteristics of fluorescent probes.

### CROSS-REFERENCE TO RELATED APPLICATIONS

This application is a continuation of PCT/CN2025/086786, filed on Apr. 2, 2025 and claims priority of Chinese Patent Application No. 202411089304.X, filed on Aug. 9, 2024, the entire contents of which are incorporated herein by reference.

### TECHNICAL FIELD

The present disclosure relates to the technical field of optical microscopy, and specifically to a deep learning-based super-resolution fluorescence lifetime imaging microscopy (SR-FLIM) method.

### BACKGROUND

FLIM, as a cutting-edge optical imaging method, has extensive application value in the field of scientific research. By precisely measuring the average time required for fluorescent molecules to transition from an excited state to a ground state, known as a fluorescence lifetime, FLIM provides researchers with unique insights into the structural and environmental properties of fluorophores. In the field of biology, FLIM is widely applied in cell imaging and biological labeling. By measuring the fluorescence lifetime of intracellular fluorescent molecules, researchers can gain insights into cellular structures, functions, and interactions between biomolecules, thereby providing robust support for disease diagnosis and therapeutic development. In the fields of chemistry and materials science, through fluorescence lifetime measurements, the researchers can uncover the internal chemical structure, defect states, and energy transfer processes within materials, thereby providing important evidence for the optimization and design of material properties. Therefore, FLIM plays an important role in multiple fields such as biology, chemistry, and materials science.

However, due to light diffraction, the spatial resolution of FLIM remains constrained by the same limitations as conventional optical microscopy. Consequently, it fails to meet the requirements for high-resolution studies of intricate intracellular structures and dynamic processes thereof, thereby restricting its applicability at microscopic scales. Currently, mainstream SR imaging techniques include stimulated emission depletion (STED) microscopy, structured illumination microscopy (SIM), single-molecule localization microscopy (SMLM), and minimal flux (MINFLUX) nanoscopy. These techniques have significantly enhanced imaging resolution, thereby advancing the development of microscopic imaging technologies. However, the implementation of these SR imaging techniques is often hindered by challenges such as excessively high laser power, slow imaging speed, and high costs associated with imaging systems.

In recent years, deep learning has achieved remarkable breakthroughs and advancements across various fields. As a calculation model simulating the structure and function of human brain's neural networks, the deep learning can autonomously extract useful features from vast data by constructing deep neural networks, thereby achieving efficient execution of tasks such as classification, recognition, and prediction. In the field of image recognition, the deep learning has superseded conventional image processing algorithms, emerging as one of the most advanced methodologies currently available. Moreover, the deep learning has demonstrated promising applications in denoising and enhancement processing of fluorescence microscopy images, enhancing clarity and contrast of the images, thereby significantly advancing imaging quality.

In response to the growing demand for SR-FLIM in modern optical microscopy, the present disclosure provides the development of a novel FLIM with SR capability. The core of this technology lies in achieving a significant improvement in spatial resolution without increasing the complexity or cost of the imaging system, while maintaining the accuracy of fluorescence lifetime measurements. The development and application of this innovative technology are expected to revolutionize optical microscopy, promoting in-depth exploration of related research and supporting the vigorous growth of interconnected fields.

### SUMMARY

### I. Technical Problem to Be Solved

In view of the deficiencies of the related art, the present disclosure provides a deep learning-based SR-FLIM method, achieving SR-FLIM within a conventional confocal FLIM system, surpassing spatial resolution limitations of FLIM, and solving the problems mentioned in the background.

II. Technical Solutions

To realize the above objective, the present disclosure provides the following technical solutions. A deep learning-based SR-FLIM method includes the steps of:

S1, performing fluorescence microscopic imaging on a sample to obtain confocal intensity images and STED intensity images at a same location;

S2, co-registering the acquired confocal and STED intensity images;

S3, pairing the co-registered confocal and STED intensity images as input (Input) and ground truth (GT) to assemble a dataset;

S4, partitioning the dataset into training and validation sets following a predefined ratio;

S5, constructing a network, and selecting hyperparameters and an optimizer;

S6, inputting the training set into the network for training;

S7, performing forward propagation and backpropagation, updating weights and checking for convergence, and reverting to Step 6 if the convergence is not achieved;

S8, determining whether the network performs well on the validation set, and repeating the operation of S5 if the performance is not good;

S9, preparing a sample for FLIM;

S10, obtaining FLIM data from a confocal FLIM system; and

S11, generating a SR-FLIM image by combining the SR intensity information with the fluorescence lifetime information.

Preferably, the sample in S1 is a fluorescent stained sample subjected to confocal FLIM, obtaining the FLIM data containing fluorescence spatiotemporal information.

Preferably, in S6, the trained network is loaded, confocal FLIM data is read to extract its intensity component, and the component is fed into the network for testing after scaling to obtain SR intensity information I(x, y).

Preferably, in S11, a fluorescence decay curve of the FLIM data is fitted to obtain a fluorescence lifetime value for each pixel, denoted as τ(x, y), in which τ(x, y) represents normal fluorescence lifetime information, while I(x, y) represents SR fluorescence intensity information. Finally, an all-ones matrix ones(x, y) is generated with identical pixel dimensions as the acquired images, the fluorescence intensity I(x, y) and the fluorescence lifetime τ(x, y) are normalized, the normalized fluorescence intensity as a value (V) channel, the fluorescence lifetime information as a hue (H) channel, and the all-ones matrix as a saturation(S) channel are merged into a three-channel HSV image, and the HSV image is converted to a red, green, blue (RGB) image to obtain an intensity-weighted fluorescence lifetime image, namely a SR-fluorescence lifetime image.

Preferably, in S10, the FLIM data obtained from the confocal FLIM system is partitioned into two processing pathways: one for extracting intensity information from the FLIM data, and scaling the information based on predefined mean and variance parameters before being input into the trained network to generate SR intensity information, and the other for analyzing the FLIM data by fitting the fluorescence decay curve to obtain fluorescence lifetime information.

Preferably, the sample requires a stage during operation, and the stage is used for positioning and fixing the sample to be tested, and performing three-dimensional motion control on the sample.

### III. Beneficial Effects

Compared to the related art, the present disclosure provides a deep learning-based SR-FLIM method, which has the following beneficial effects.

This deep learning-based SR-FLIM method involves acquiring paired fluorescence images, specifically capturing non-SR images and SR images at the same location of sample. Moreover, a deep learning model is constructed and trained using extensive paired fluorescence intensity image data for learning. When diffraction-limited non-SR images are input, this model can generate high-quality SR fluorescence intensity images. Furthermore, a SR-fluorescence lifetime image is produced by combining the SR intensity images with fluorescence lifetime information derived from curve fitting. According to the method provided by the present disclosure, the spatial resolution of the fluorescence lifetime image is significantly enhanced, thereby providing robust technical support for research in fields such as biological, chemical, and materials science.

### BRIEF DESCRIPTION OF THE DRAWINGS

FIG. 1 shows a flowchart of a deep learning-based SR-FLIM method according to the present disclosure;

FIG. 2 shows a schematic diagram of a deep learning-based SR-FLIM system according to the present disclosure;

FIG. 3 shows a laser pulse profile and corresponding fluorescence decay curve according to the present disclosure;

FIG. 4 (a) shows a low-resolution fluorescence intensity image; and

FIG. 4 (b) shows a SR-fluorescence lifetime image.

### DETAILED DESCRIPTION

The technical solution in the embodiment of the present disclosure is further described clearly and completely below in combination with the accompanying drawings. Obviously, the embodiment described is only some, rather than all embodiments of the present disclosure. Based on the embodiment of the present disclosure, all other embodiments obtained by those ordinary skilled in the art without creative efforts fall within the scope of protection of the present disclosure.

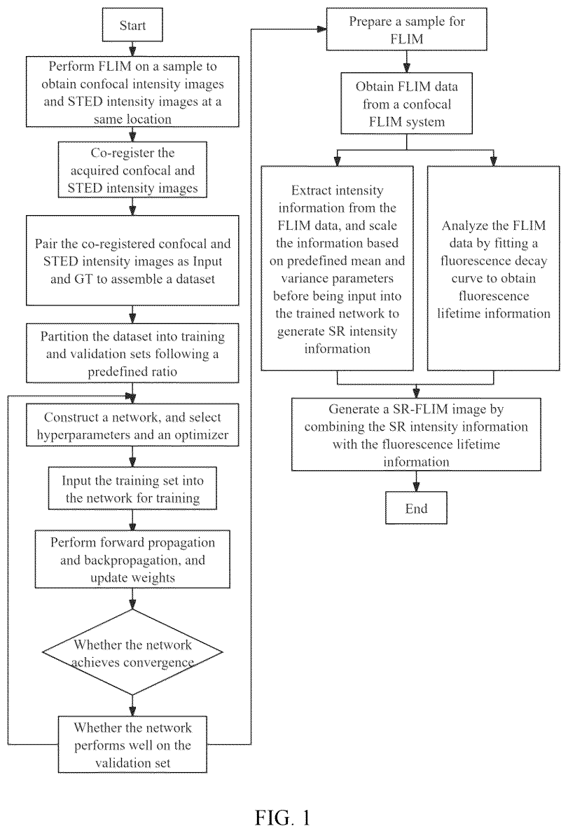

Referring to FIG. 1, a deep learning-based SR-FLIM method includes the steps that:

In S1, FLIM is performed on a sample to obtain confocal intensity images and STED intensity images at the same location, in which the sample is a fluorescent stained sample subjected to confocal FLIM, obtaining FLIM data containing fluorescence spatiotemporal information. Moreover, the sample requires a stage during operation, and the stage is used for positioning and fixing the sample to be tested, and performing three-dimensional motion control on the sample.

In S2, the acquired confocal and STED intensity images are co-registered.

In S3, the co-registered confocal and STED intensity images as Input and GT are paired to assemble a dataset.

In S4, the dataset is partitioned into training and validation sets following a predefined ratio.

In S5, a network is constructed, and hyperparameters and an optimizer are selected.

In S6, the training set is input into the network for training, the trained network is loaded, confocal FLIM data is read to extract its intensity component, and the component is fed into the network for testing after scaling to obtain SR intensity information I(x, y).

In S7, forward propagation and backpropagation are performed, weights are updated to check for convergence; and if the convergence is not achieved, the operation of S6 is repeated.

In S8, it is determined whether the network performs well on the validation set, and if the performance is not good, the operation of S5 is repeated.

In S9, a sample for FLIM is prepared.

In S10, FLIM data is obtained from a confocal FLIM system, and the FLIM data obtained from the confocal FLIM system is partitioned into two processing pathways: one for extracting intensity information from the FLIM data, and scaling the information based on predefined mean and variance parameters before being input into the trained network to generate SR intensity information I(x, y), and the other for analyzing the FLIM data by fitting a fluorescence decay curve to obtain fluorescence lifetime information τ(x, y).

In S11, a SR-FLIM image is generated by combining the SR intensity information with the fluorescence lifetime information, and the fluorescence decay curve of the FLIM data is fitted to obtain a fluorescence lifetime value for each pixel, denoted as τ(x, y), in which τ(x, y) represents normal fluorescence lifetime information, while I(x, y) represents SR fluorescence intensity information. Finally, an all-ones matrix ones(x, y) is generated with identical pixel dimensions as the acquired images, the fluorescence intensity I(x, y) and the fluorescence lifetime τ(x, y) are normalized, the normalized fluorescence intensity as a V channel, the fluorescence lifetime information as an H channel, and the all-ones matrix as an S channel are merged into a three-channel HSV image, and the HSV image is converted to an RGB image to obtain an intensity-weighted fluorescence lifetime image, namely a SR-fluorescence lifetime image.

For data acquisition of network training: the confocal intensity images and STED-SR intensity images are acquired at the same location of the sample during each acquisition process, with this data acquired using a commercial STED-SR microscopy system. In this imaging system, confocal intensity images are obtained when the applied STED laser power is set to zero, whereas STED-SR intensity images are obtained when a certain value of STED laser power is applied. Under conventional operating conditions, confocal microscopic images and STED images within the same field of view may exhibit rigid or non-rigid distortions due to system miscalibration and drift during multi-modal imaging. Therefore, image registration is required between data pairs, for which feature point detection and pairing based on oriented FAST and rotated BRIEF (ORB) are employed. At this point, the low-resolution (confocal) and SR (STED) intensity images have been acquired, serving as Input and GT to assemble the dataset. Following this, m groups of data are generated by random combination as the training set and n groups as the validation set (m, n∈natural number (N), and m: n=5:1), with strict separation maintained between the data constituting the training set and the data constituting the validation set.

The algorithm is further configured such that: for the network training, mini batch training (batch_size=2^{k}, k∈N) is employed to accelerate the training. A loss function is formulated as: loss=α×MSELoss(X, Y)+β×SSIMLoss(X, Y), where X represents a network output (Output) and Y represents the GT. The MSELoss refers to mean square error, ensuring each pixel value of Output conforms to GT, while the SSIMLoss refers to structure similarity index measure, ensuring global structure features in Output conform to GT, and α and β represent coefficients for two error terms. A root mean square propagation (RMSprop) optimizer is selected, with a learning rate set to lr=3e−4. To accelerate network convergence, each batch is first scaled to a range of [−1,1] before being fed into the network during training. The network is trained for 500 epochs or until a module named Early stop is triggered, with its performance evaluated on the validation set every 5 epochs.

For data acquisition and testing procedures: after the network has achieved convergence and demonstrated satisfactory performance on the validation set, testing may be conducted by preparing the fluorescent stained sample and performing confocal FLIM to acquire the FLIM data containing fluorescence spatiotemporal information. The trained network is loaded, confocal FLIM data is read to extract its intensity component, and the component is fed into the network for testing after scaling to obtain the SR intensity information I(x, y). Furthermore, the fluorescence decay curve of the FLIM data is fitted to obtain the fluorescence lifetime value for each pixel, denoted as τ(x, y), in which τ(x, y) represents the normal fluorescence lifetime information, while I(x, y) represents the SR fluorescence intensity information. Finally, the all-ones matrix ones(x, y) is generated with the identical pixel dimensions as the acquired images, the fluorescence intensity I(x, y) and the fluorescence lifetime τ(x, y) are normalized, and the normalized fluorescence intensity as the V channel, the fluorescence lifetime information as the H channel, and the all-ones matrix as the S channel are merged into the three-channel HSV image. The HSV image is converted to the RGB image to obtain the intensity-weighted fluorescence lifetime image, namely the SR-fluorescence lifetime image containing normal fluorescence lifetime information and SR structural information. According to the above principle, the present disclosure achieves SR-FLIM within a conventional confocal FLIM system, surpassing spatial resolution limitations of FLIM.

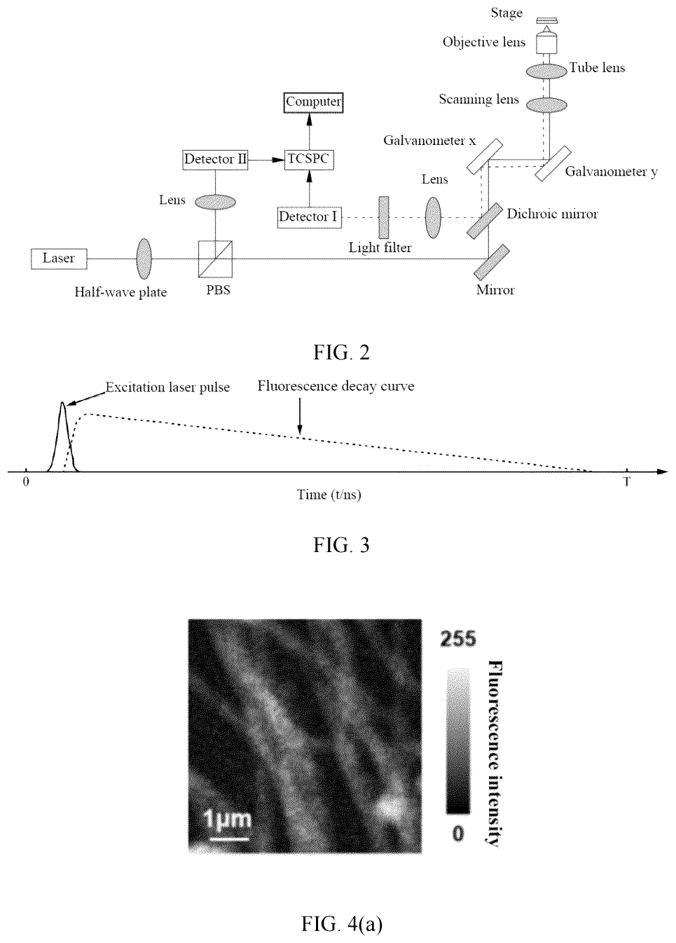

Referring to FIG. 2, during the above process from S1 to S11, the following components are required:
a laser, for generating picosecond pulsed laser output;
a half-wave plate, for adjusting a polarization direction of the laser;
a polarizing beam splitter (PBS), for laser beam splitting, and controlling the energy ratio between reflected and transmitted laser beams in combination with the half-wave plate;
a mirror, for altering a propagation direction of the laser;
a dichroic mirror, for transmitting excitation light and reflecting a fluorescence signal;
a galvanometer x, for performing transverse synchronized scanning of the two laser beams;
a galvanometer y, for performing longitudinal synchronized scanning of the two laser beams, and achieving area array imaging of the sample in conjunction with the galvanometer x;
a scanning lens, positioned behind the galvanometers, and used for collecting laser beams for area array scanning;
a tube lens, for forming a microscope system in conjunction with an objective lens;
the objective lens, for focusing the laser onto the sample while collecting the fluorescence signal reflected from the sample;
the stage, for positioning and fixing the sample to be tested, and performing three-dimensional motion control on the sample;
lenses, for focusing the laser beams;
a light filter, for transmitting the fluorescence signal, and removing stray light other than fluorescence to improve a signal-to-noise ratio of image;
a detector I, for collecting and amplifying the fluorescence signal using a photomultiplier tube or an avalanche photodiode;
a detector II, for detecting the reflected laser from the PBS in a Gaussian excitation path, serving as a reference signal for FLIM;
a time-correlated single photon counter (TCSPC), for recording spatiotemporal information of the fluorescence signal; and
a computer, for controlling software to acquire images, store data and process image data.

It can be seen from FIG. 2 that this system has only one picosecond pulsed laser light source. After the laser is emitted, the polarization direction is adjusted through the half-wave plate, and the laser is split into two beams through the PBS. The reflected beam from the PBS is collected by the detector II, serving as the reference signal for FLIM. The transmitted beams is reflected by the mirror, passes through the dichroic mirror, and is scanned by the galvanometer x the galvanometers y. Moreover, the beam sequentially passes through the scanning lens, the tube lens, and the objective lens before being focused onto the sample. Upon laser excitation, the sample emits fluorescence. The fluorescence signal retraces its original path after collection by the objective lens, sequentially passing through the tube lens, the scanning lens, and the galvanometers, before being reflected by the dichroic mirror. After being focused by the lenses and filtered by the light filter, the fluorescence signal is detected by the detector I. Simultaneously, the fluorescence signal from the detector I and the reference signal from the detector II are acquired by the TCSPC, and these data are transmitted to the computer for storage and processing.

Referring to FIG. 3, an impulse frequency of the excitation laser is defined as a detection time (T) for the fluorescence signal. Therefore, a laser pulse and a complete spontaneous emission process are contained in each detection time. In this figure, a solid black line represents the laser pulse, and a dashed black line represents a fluorescence decay curve generated by spontaneous emission following laser excitation. The fluorescence lifetime information for each pixel in the image, denoted as τ(x, y), can be acquired through fitting of the fluorescence decay curve.

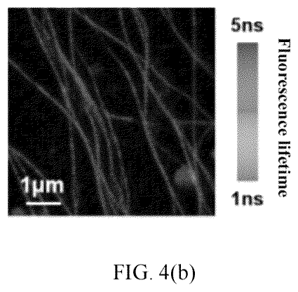

Referring to FIG. 4(a) and FIG. 4(b), microtubule structures of cells are stained using a fluorescent dye. Moreover, the FLIM data of the sample is acquired with the confocal FLIM system. The FIG. 4(a) shows a low-resolution confocal intensity image directly generated according to photon count distribution in the FLIM data, and the FIG. 4(b) shows a SR-fluorescence lifetime image obtained using the method provided in the present disclosure. As evidenced by image comparison results from FIG. 4(a) and FIG. 4(b), the images obtained through the present disclosure simultaneously reveal enhanced structural details and richer fluorescence lifetime information of the sample.

The method of the present disclosure can be applied to any confocal FLIM system. It is particularly suitable for dynamic imaging of live cells and studying interaction processes between different subcellular structures, thereby providing robust technical support for further exploration in the biomedical field.

It is to be noted that the terms “include” or any other variation thereof are intended to cover a non-exclusive inclusion, so that a process, method, article, or apparatus with a series of elements includes not only those elements but also other elements not explicitly listed, or elements inherent to such process, method, article, or apparatus. Without further more limitations, elements limited by statements “include a . . .” do not preclude the existence of other identical elements in the process, method, article or device.

Although the above embodiments of the present disclosure have been shown and described, a person of ordinary skill in the art may make several changes, modifications, substitutions and variations without departing from the principles and spirit of the present disclosure, and the scope of the present disclosure is limited by the attached claims and equivalents thereof.

1. A deep learning-based super-resolution fluorescence lifetime imaging microscopy (SR-FLIM) method, comprising the steps of:
S1, performing fluorescence microscopic imaging on a sample to obtain confocal intensity images and stimulated emission depletion (STED) intensity images at a same location;
S2, co-registering the acquired confocal and STED intensity images;
S3, pairing the co-registered confocal and STED intensity images as input (Input) and ground truth (GT) to assemble a dataset;
S4, partitioning the dataset into training and validation sets following a predefined ratio;
S5, constructing a network, and selecting hyperparameters and an optimizer;
S6, inputting the training set into the network for training, loading the trained network, reading confocal FLIM data to extract its intensity component, and feeding the component into the network for testing after scaling to obtain SR intensity information I(x, y);
S7, performing forward propagation and backpropagation, updating weights and checking for convergence, and repeating the operation of S6 if the convergence is not achieved;
S8, determining whether the network performs well on the validation set, and repeating the operation of S5 if the performance is not good;
S9, preparing a sample for FLIM;
S10, obtaining FLIM data from a confocal FLIM system, partitioning the FLIM data obtained from the confocal FLIM system into two processing pathways: one for extracting intensity information from the FLIM data, and scaling the information based on predefined mean and variance parameters before being input into the trained network to generate SR intensity information, and the other for analyzing the FLIM data by fitting a fluorescence decay curve to obtain fluorescence lifetime information; and
S11, generating a SR-FLIM image by combining the SR intensity information with the fluorescence lifetime information, and fitting the fluorescence decay curve of the FLIM data to obtain a fluorescence lifetime value for each pixel, denoted as τ(x, y), wherein τ(x, y) represents normal fluorescence lifetime information, while I(x, y) represents SR-fluorescence intensity information; and generating an all-ones matrix ones(x, y) with identical pixel dimensions as the acquired images, normalizing the fluorescence intensity I(x, y) and the fluorescence lifetime τ(x, y), merging the normalized fluorescence intensity as a value (V) channel, the fluorescence lifetime information as a hue (H) channel, and the all-ones matrix as a saturation(S) channel into a three-channel HSV image, and converting the HSV image to a red, green, blue (RGB) image to obtain an intensity-weighted fluorescence lifetime image, namely a SR-fluorescence lifetime image.

2. The deep learning-based SR-FLIM method according to claim 1, wherein the sample in S1 is a fluorescent stained sample subjected to confocal FLIM, obtaining the FLIM data containing fluorescence spatiotemporal information.

3. The deep learning-based SR-FLIM method according to claim 1, wherein the sample requires a stage during operation, and the stage is used for positioning and fixing the sample to be tested, and performing three-dimensional motion control on the sample.
